(19) United States
(12) Patent Application Publication
(10) Pub. No.: US 2013/0094567 A1
(43) Pub. Date: Apr. 18, 2013

(54) APPARATUS AND METHODS FOR PERFORMING BLOCK MATCHING ON A VIDEO STREAM

(71) Applicants: Amichay Amitay, Hod-Hasharon (IL); Alexander Rabinovitch, Kfar Yona (IL); Leonid Dubrovin, Karney Shomron (IL)

(72) Inventors: Amichay Amitay, Hod-Hasharon (IL); Alexander Rabinovitch, Kfar Yona (IL); Leonid Dubrovin, Karney Shomron (IL)

(73) Assignee: LSI CORPORATION, Milpitas, CA (US)

(21) Appl. No.: 13/275,715

(22) Filed: Oct. 18, 2011

(51) Int. Cl. H04N 7/26; G09G 5/39; G06F 13/14; G09G 5/36

(52) U.S. Cl. 375/240.2; 345/547; 345/531; 345/519; 375/E07.126

(57) ABSTRACT

A data processing system for processing a video stream comprises memory array circuitry, memory access circuitry, and video processing circuitry. The memory array circuitry is characterized by a width and a height. The memory access circuitry is operative to cause, through a series of write operations, a series of two-dimensional data representations of different respective regions in a frame of the video stream to be stored in the memory array circuitry. The write operations occur such that only data missing from the memory array circuitry is written to the memory array circuitry during each write operation and such that the data is written modulo at least one of the width and the height of the memory array circuitry. Lastly, the video processing circuitry is operative to perform block matching on the video stream at least in part utilizing the series of two-dimensional data representations stored in the memory array circuitry.

### FIELD OF THE INVENTION

The present invention relates generally to electrical and electronic devices and circuits, and more particularly relates to apparatus and methods for video processing by means of block matching.

### BACKGROUND OF THE INVENTION

Motion compensation is a technique employed in the encoding of video data for the purpose of video compression. Motion compensation involves describing a current video frame in terms of the transformation of a different reference video frame. When video frames can be accurately synthesized from previously transmitted/stored video frames, the amount of data required to describe a video frame is reduced and video compression efficiency is improved.

Motion compensation may work in conjunction with motion estimation, which is the process of determining motion vectors that describe the transformation from one video frame to another. Many motion estimation schemes utilize a technique called “block matching.” Each video frame is divided into a fixed number of square “macro blocks.” For each macro block in a current video frame, a search is made over an area of an image in a reference video frame in order to find a respective matching macro block in the reference video frame. The reference video frame is frequently a video frame prior to the current video frame, although this need not be the case. Once such a matching macro block is discovered, a motion vector is then assigned that describes how that macro block moves from one location in the reference video frame to another location in the current video frame. Such movement calculated for all the macro blocks in the current video frame constitutes the motion estimate for the current video frame.

A typical macro block size is 16×16 pixels, and the search area may be an additional 256 pixels on all four sides of the macro block's position in the current video frame. Ultimately, the matching of one macro block with another is based on the output of one or more block matching algorithms. Such block matching algorithms are in wide usage and include Exhaustive Search, Three Step Search, New Three Step Search, Simple and Efficient Three Step Search, Four Step Search, Diamond Search, Adaptive Rood Pattern Search, and several others. When utilizing these block matching algorithms, cost functions (e.g., Mean Absolute Difference or Mean Squared Error) are determined for numerous candidate matching macro blocks within the search area. The candidate macro block with the lowest cost function is deemed the one that most closely matches the current macro block.

Motion estimation through block matching is frequently very demanding with respect to memory bandwidth (i.e., the rate at which data can be read from or stored into a memory by a processor). In fact, memory bandwidth will often limit the performance of a data processor performing video coding, video processing, and graphics applications.

### SUMMARY OF THE INVENTION

The present invention, in illustrative embodiments thereof, relates to data processing systems that utilize unique two-dimensional (2D) memory arrays to perform block matching while processing video. The 2D memory arrays are internal memory structures where data access latency is low. Moreover, embodiments of the invention populate the 2D memory arrays in such a manner that the transfer of redundant data to the 2D memory arrays is avoided while, at the same time, the need for shift and copy operations is minimized. In this manner, the invention provides data processing systems for video processing which are superior in at least speed to conventional systems.

In accordance with an embodiment of the invention, a data processing system for processing a video stream comprises memory array circuitry, memory access circuitry, and video processing circuitry. The memory array circuitry is characterized by a width and a height. The memory access circuitry is operative to cause, through a series of write operations, a series of two-dimensional data representations of different respective regions in a frame of the video stream to be stored in the memory array circuitry. The write operations occur such that only data missing from the memory array circuitry is written to the memory array circuitry during each write operation and such that the data is written modulo at least one of the width and the height of the memory array circuitry. Lastly, the video processing circuitry is operative to perform block matching on the video stream at least in part utilizing the series of two-dimensional data representations stored in the memory array circuitry.

In accordance with another embodiment of the invention, a video stream is processed by causing, through a series of write operations, a series of two-dimensional data representations of different respective regions in a frame of the video stream to be stored in memory array circuitry defined by a width and a height. The write operations occur such that only data missing from the memory array circuitry is written to the memory array circuitry during each write operation and such that the data is written modulo at least one of the width and the height of the memory array circuitry. Subsequently, block matching is performed on the video stream at least in part utilizing the series of two-dimensional data representations stored in the memory array circuitry.

In accordance with yet another embodiment of the invention, an integrated circuit for processing a video stream comprises memory array circuitry, memory access circuitry, and video processing circuitry. The memory array circuitry is characterized by a width and a height. The memory access circuitry is operative to cause, through a series of write operations, a series of two-dimensional data representations of different respective regions in a frame of the video stream to be stored in the memory array circuitry. The write operations occur such that only data missing from the memory array circuitry is written to the memory array circuitry during each write operation and such that the data is written modulo at least one of the width and the height of the memory array circuitry. Lastly, the video processing circuitry operative to perform block matching on the video stream at least in part utilizing the series of two-dimensional data representations stored in the memory array circuitry.

These and other features, objects and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 shows a block diagram of at least a portion of an illustrative data processing system, in accordance with an embodiment of the invention;

FIG. 2 shows a flowchart of illustrative steps for use in implementing video processing utilizing the FIG. 1 data processing system, in accordance with an embodiment of the invention;

FIG. 3 shows a diagrammatic representation of two illustrative search areas associated with two neighboring retrieving macro blocks in a given row of a video frame, in accordance with an embodiment of the invention;

FIG. 4 shows a diagrammatic representation of illustrative search areas associated with two neighboring retrieving macro blocks that are located at a rightmost edge of a video frame, in accordance with an embodiment of the invention;

FIGS. 5A-5C show diagrammatic representations of illustrative memory array content for search areas associated with three neighboring macro blocks, in accordance with an embodiment of the invention;

FIGS. 6A-6D show diagrammatic representations of illustrative memory array content for search areas associated with four neighboring macro blocks in a laterally oversized 2D memory array, in accordance with an embodiment of the invention; and

FIG. 7 shows a diagrammatic representation of illustrative memory array content for a search area associated with a macro block in a laterally and vertically oversized 2D memory array, in accordance with an embodiment of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF THE INVENTION

The present invention, according to aspects thereof, will be described herein in the context of illustrative methods and data processing systems for video processing, video coding, and graphics applications. It will become apparent to those skilled in the art given the teachings herein that numerous modifications can be made to the embodiments shown that are within the scope of the present invention. That is, no limitations with respect to the specific embodiments described herein are intended or should be inferred.

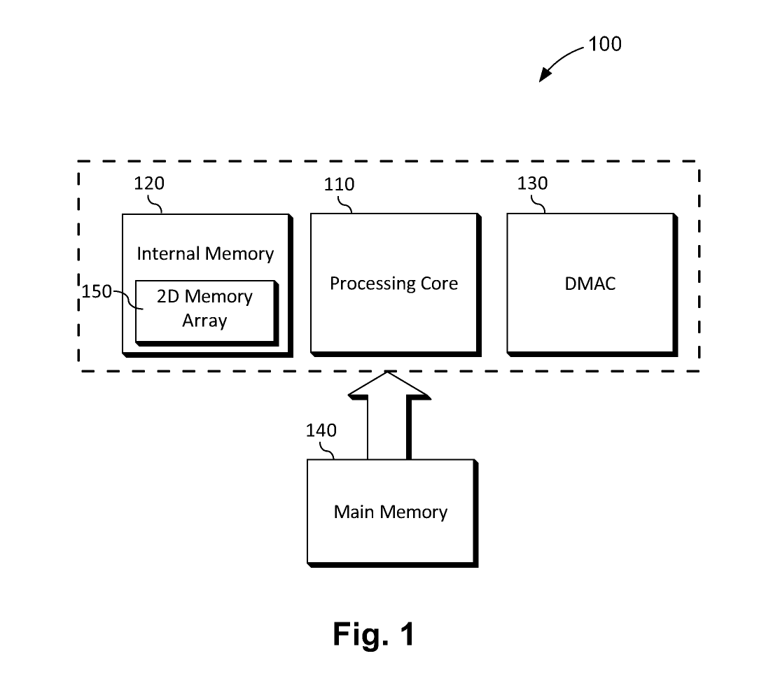

FIG. 1 shows a block diagram of at least a portion of an illustrative data processing system 100, in accordance with an embodiment of the invention. The illustrative data processing system 100 includes a processing core 110, an internal memory 120, a direct memory access controller (DMAC) 130, and a main memory 140. The internal memory 120, in turn, comprises a 2D memory array 150.

While separate blocks are shown for the elements in FIG. 1, this representation is not meant to indicate the physical implementation of these elements. Instead, this representation is merely intended to highlight some of the functionally distinct aspects of portions of the illustrative data processing system 100. When implemented physically, one or more elements of the data processing system 100 may, for example, share the same circuitry. Moreover, several elements of the illustrative data processing system 100 may, as just another example, be collectively implemented as a discrete electronic part. It may be desirable, in an embodiment of the invention, for instance, to implement the processing core 110, the internal memory 120, and the DMAC 130 as a single integrated circuit. This integrated circuit may, in turn, be tied to the main memory 140 by one or more memory busses, as required.

In the illustrative data processing system 100, the processing core 110 preferably performs various management, arithmetic, and logic functions. The internal memory 120 and main memory 140, in turn, constitute what is commonly called primary memory for the data processing system 100. In an embodiment of the invention, the internal memory 120 may, for example, form a portion of the processing core's cache memory or zero wait-state memory. In such a configuration, the internal memory 120 may have very high access speeds when compared to the main memory 140 as well as when compared to any secondary or tertiary memory components (not explicitly shown). In fact, in such a configuration, the internal memory 120 may have access speeds near that of the processing core's registers, typically the fastest memory elements in any data processing system.

In embodiments of the invention, the internal memory 120 and the main memory 140 may comprise, for example, random access memories (RAMs), such as, but not limited to, static RAMs, dynamic RAMs, synchronous dynamic RAMs (SDRAMs), magnetoresistive RAMs, flash RAMs, phase-change RAMs, or a combination thereof. The use of one or more forms of Double Data Rate SDRAM (DDR SDRAM) for the main memory 140 may be beneficial in allowing fast data transfers conducive to intensive video processing. Nevertheless, it is stressed that the invention is not limited to any particular type of memory, and, for that reason, any other equally suitable memory type or combination of memory types may be utilized and the result will still come within the scope of the invention.

Speed advantages may be imparted to the illustrative data processing system 100 by having memory fetches from the main memory 140 to the internal memory 120 be conducted, at least in part, through the use of the DMAC 130. When the processing core 110 determines that a block of data is ready to be moved, it may, for example, instruct the DMAC 130 to execute the fetch. When the DMAC 130 is triggered in this manner, the processing core 110 may temporarily relinquish control of one or more memory busses to the DMAC 130. The DMAC 130 may then serve as a surrogate processor by directly generating addresses and reading and writing data while allowing the processing core 110 to continue to perform other functions not necessarily related to the fetch, such as, but not limited, mathematical computations. When the DMAC 130 has completed transferring the requested data, the DMAC 130 may then assert an interrupt to the processing core 110 to signal that the data has been moved. At this point, the processing core 110 may initiate a new DMAC transfer or invoke any necessary routines to process data that has just been moved.

Once so formed, the illustrative data processing system 100 can, in an embodiment of the invention, be utilized to encode video data through the implementation of motion estimation. The encoding of video through motion estimation is widely performed and will therefore be familiar to one skilled in the video processing arts. Motion estimation is utilized, for example, when performing video processing in accordance with the MPEG-2 and MPEG-4 Advanced Video Coding video coding standards. Moreover, such video processing is described in a number of readily available references, including, for example, J. Watkinson, The MPEG handbook: MPEG-1, MPEG-2, MPEG-4, Focal Press, 2004, which is hereby incorporated by reference herein. Once fully processed, video may be transmitted or may be stored on a non-transitory storage medium such as, but not limited to, a Digital Video Disc (DVD) or the like.

Briefly, motion estimation is the process of determining motion vectors that describe the transformation from one video frame to another for the purpose of reducing the amount of data required to describe a video frame and thereby improve compression efficiency. Such motion estimation utilizes a technique called block matching. Using block matching, each video frame is divided into a fixed number of square “macro blocks.” For each macro block in a current video frame to be coded (hereinafter a “retrieving macro block”), a search is then made over a continuous area of an image in a reference video frame in order to find a respective matching macro block in the reference video frame (hereinafter a “matching macro block”). The reference video frame is frequently a video frame prior to the current video frame, although this need not be the case. Once a matching macro block is discovered, a motion vector is then assigned that describes how that macro block moves from one location in the reference video frame to another location in the current video frame. Such movement calculated for all the retrieving macro blocks in the current video frame constitutes the motion estimate for the current video frame. Notably, if no acceptable matching macro block is determined to be present in the search area for a given retrieving macro block, the encoder may have the option of more fully coding that macro block rather than utilizing motion vectors to describe it. In this manner, high quality video may be maintained. Moreover, in some video coding standards, a macro block can be further divided into sub-blocks and a search performed for these smaller blocks.

In a non-limiting and purely illustrative embodiment of the invention, for example, a retrieving macro block may be 16×16 pixels in size, and the search area associated with that retrieving macro block might encompass the area of that macro block plus an additional 32 pixels on all four sides of the macro block. With these dimensions, the search area will ultimately have an area of 80×80 pixels, assuming the search area is not limited by the edges of the video frame. If one assumes that each pixel is represented by a byte of data (i.e., 8 bits), a macro block may correspond to about 256 bytes of data, and the corresponding search area may correspond to about 6.4 kilobytes (KB) of data. Nevertheless, it is stressed that these areal dimensions for the macro block and the search area are largely arbitrary and are not intended to limit the scope of the invention. Other search areas within the scope of the invention may be substantially larger than 80×80 pixels. When dealing with high definition video, it may, for example, be advantageous to utilize a search area of 528×528 pixels, in which case the search area will correspond to about 278 KB of data.

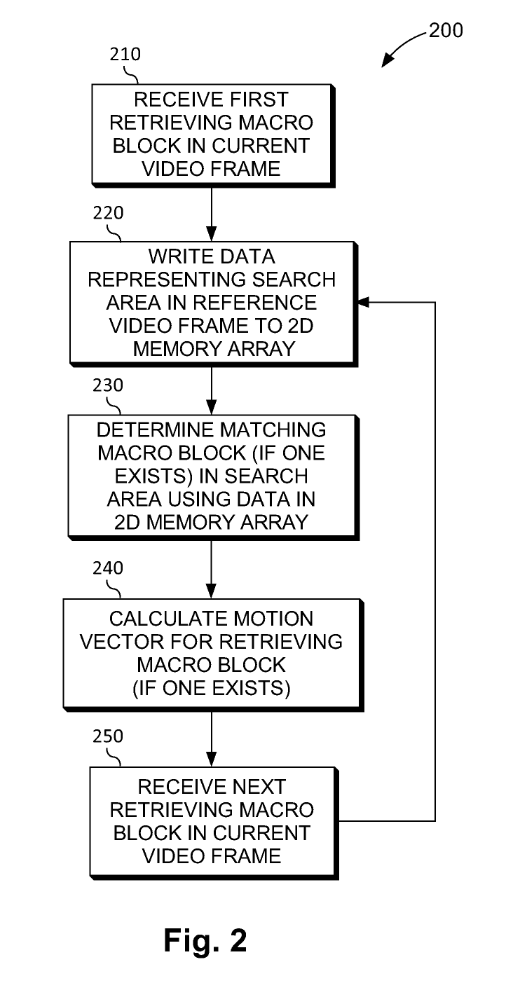

FIG. 2 shows a flowchart of illustrative steps for implementing video processing (more specifically, motion estimation) utilizing the data processing system 100, in accordance with an embodiment of the invention. In step 210, the data processing system 100 receives the first retrieving macro block from a current video frame of a video stream. This first retrieving macro block may, for instance, be the macro block located at the upper left corner of the current video frame, although the invention is not limited to any specific location of the first retrieving macro block. Subsequently, in step 220, the processing core 110 causes the DMAC 130 to write data representing a continuous search area in a reference video frame from the main memory 140 to the 2D memory array 150 of the internal memory 120. The search area preferably comprises that portion of the reference video frame corresponding to the retrieving macro block as well as an additional region on each side of that macro block. The data in the 2D memory array 150 then becomes a two-dimensional data representation of the pixels in the two-dimensional search area of the reference video frame.

Next, in step 230, the processing core 110 determines if a matching macro block for the retrieving macro block is present in the search area. The matching of one macro block with another may be based on the results of a block matching algorithm. Such block matching algorithms are in wide usage and include Exhaustive Search, Three Step Search, New Three Step Search, Simple and Efficient Three Step Search, Four Step Search, Diamond Search, Adaptive Rood Pattern Search, and several others. When utilizing these block matching algorithms, cost functions (e.g., Mean Absolute Difference or Mean Squared Error) are determined for numerous candidate matching macro blocks within the search area. Ultimately, the candidate macro block with the lowest cost function is deemed the one that most closely matches the retrieving macro block.

Assuming a matching macro block is found in step 230, the data processing system then moves to step 240, wherein a motion vector is calculated for the retrieving macro block based on its position in the current video frame in relation to the position of the matching macro block in the reference video frame. Once this is accomplished, the data processing system 100 preferably moves on to another retrieving macro block, as indicated in step 250.

The next retrieving macro block chosen in step 250 will depend on the pattern in which the retrieving macro blocks in the current video frame are analyzed. If the macro blocks are chosen to be analyzed top-to-bottom and left-to-right (by what is hereinafter called a “standard raster pattern”), for example, the next retrieving macro block will be the macro block to the immediate right of the last retrieving macro block unless the last retrieving macro block happens to be located at the rightmost edge of the video frame. When the latter condition occurs, the next retrieving macro block will instead be the macro block in the row immediately below that last retrieving macro block, but now at the leftmost edge of the video frame. If, on the other hand, the retrieving macro blocks are chosen to be analyzed top-to-bottom while alternating left-to-right and right-to-left by row (by what is hereinafter called an “alternating raster pattern”), the next retrieving macro block within a given row will be the macro block to the immediate right or left of the last retrieving macro block, depending on the row. When the last retrieving macro block occupies a position on a leftmost or rightmost edge of the current video frame, the next retrieving macro block will be a neighboring macro block in the row immediately below that last retrieving macro block.

In any case, independent of the exact pattern utilized (e.g., raster pattern) in the methodology 200, the steps 220-250 preferably continue (e.g., reiteratively) until all of the macro blocks in the current video frame have been analyzed and the motion estimate is fully calculated for all the macro blocks in the current video frame.

Because motion estimation through block matching is frequently very demanding with respect to memory bandwidth, even relatively minute improvements to data handling may result in substantial and highly desirable enhancements to overall video processing speed. As indicated in the method 200, the speed of video processing in embodiments of the invention is enhanced by transferring data representing the search regions of a reference video frame from the main memory 140 to the internal memory 120 (more particularly, the 2D memory array 150), where data access latency is lower. Embodiments of the invention may also achieve additional speed gains by: 1) only transferring the minimum amount of data to the 2D memory array 150; and 2) avoiding, to the extent possible, the need to perform shift or copy operations on the data in the 2D memory array 150. Transferring data to the 2D memory array 150 requires memory fetches which consume processing core and/or DMAC cycles. Likewise, shifting data requires processing core cycles to read and write data to the same memory area. Copying data suffers from the need to use a second memory to act as a buffer during the copying process. Consequently, reducing and/or avoiding these operations in accordance with aspects of the invention may thereby provide substantial benefits.

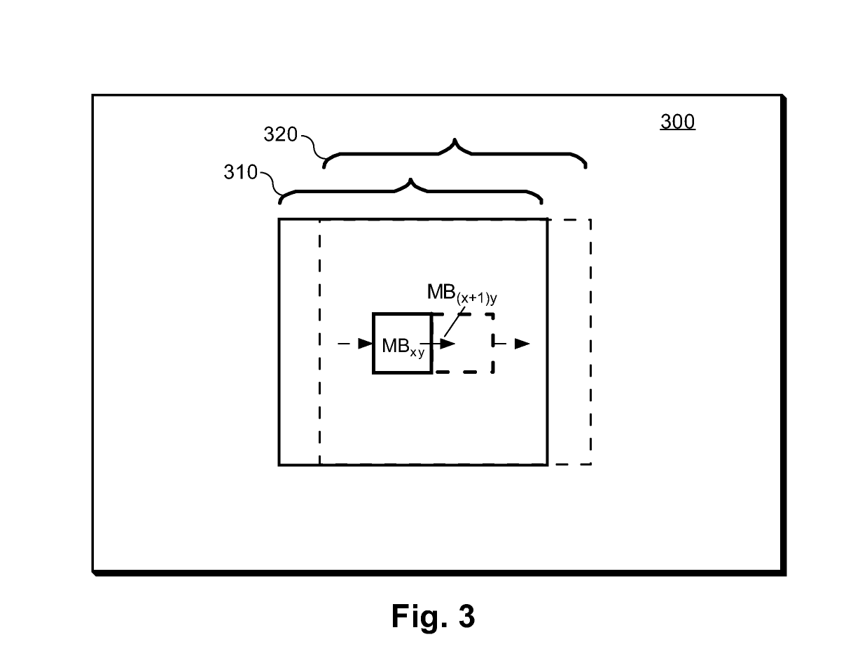

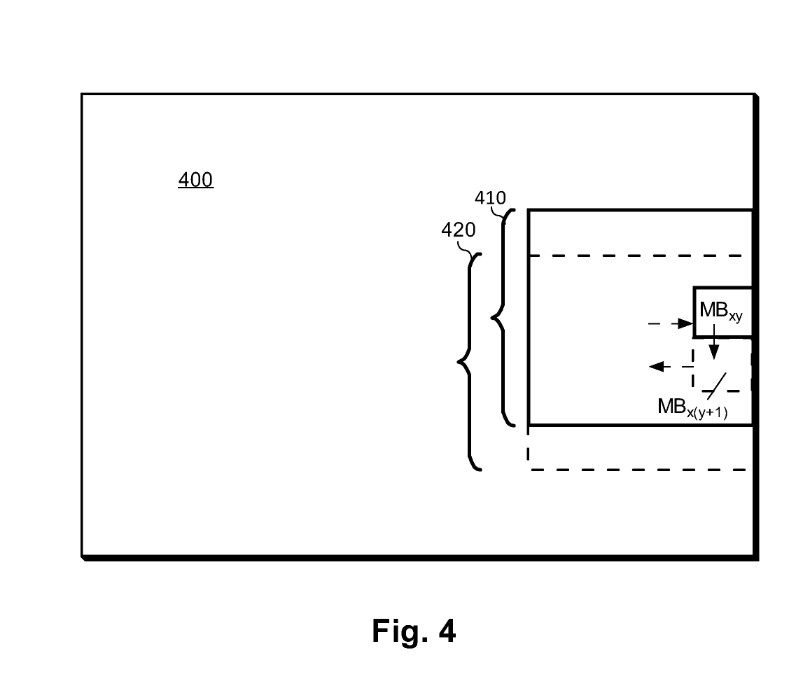

FIGS. 3 and 4 may help to illustrate the search areas in a reference video frame associated with two neighboring retrieving macro blocks and how those search areas change as the analyses steps from one retrieving macro block to another retrieving macro block. FIG. 3, for example, shows a diagrammatic representation of two illustrative search areas associated with two neighboring retrieving macro blocks in a given row of a video frame 300, where the analyses happens to be taking effect from left-to-right. As previously stated, the invention is not limited by the manner in which the retrieving macro blocks are searched. Here, the retrieving macro block at column x and row y, MB_{xy}, is associated with a search area 310 in the reference video frame, while the neighboring retrieving macro block at column (x+1) and row y, MB_{(x+1)y}, is associated with a search area 320. In a similar manner, FIG. 4 shows a diagrammatic representation of illustrative search areas associated with two neighboring retrieving macro blocks in a video frame 400 that are located at a rightmost edge of the reference video frame, where the current video frame is being analyzed by an alternating raster pattern. Here, it will be observed that the retrieving macro block at column x and row y, MB_{xy}, is associated with a search area 410 in the reference video frame, while the neighboring retrieving macro block at column x and row (y+1), MB_{x(y+1)}, is associated with a search area 420.

In referring to the search areas 310, 320, 410, 420 in FIGS. 3 and 4, it becomes apparent that neighboring search areas overlap to a great extent. Under appropriate circumstances, additional speed gains are thereby effectuated when moving from one retrieving macro block to a neighboring retrieving macro block by only transferring the data for the new search area that differs from that already stored in the 2D memory array 150. In other words, for each successive search area, only the data for that successive search area missing from the 2D memory array 150 (hereinafter, the “missing data”) is written to the 2D memory array 150 rather than transferring data representing the entirety of the next search area. If one again assumes, for purposes of example only, macro blocks with 16×16 pixels and search areas with 80×80 pixels (with one byte per pixel), data transfer associated with moving from one retrieving macro block to another may be reduced from about 6.4 KB to only about 1.2 KB by avoiding the transfer of redundant data in this manner.

Moreover, as will be illustrated graphically below, embodiments of the invention may avoid shifting or copying operations in the 2D memory array 150 by writing data to the 2D memory array 150 such that at least some of that data is wrapped modulo the width and the height of the 2D memory array 150. In illustrative embodiments of the invention, for example, the data processing system 100 identifies the 2D memory array 150 by a START pointer, a CURRENTX pointer, a CURRENTY pointer, a WIDTH constant, and a HEIGHT constant. The START pointer defines the upper left corner of the 2D memory array 150, or an alternative starting location in the 2D memory array, while the WIDTH constant and the HEIGHT constant define the width and height, respectively, of the 2D memory array 150. Neither the START pointer, nor the WIDTH and HEIGHT constants, need change. The CURRENTX and CURRENTY pointers, on the other hand, indicate the x- and y-positions, respectively, of the current retrieving macro block in the reference video frame.

Writing data to the 2D memory array 150 such that it is wrapped modulo the width and the height of that 2D memory array 150 then becomes the process of writing data corresponding to an x- and y-position in the reference video frame (hereinafter called “X_{ref}” and “Y_{ref},” respectively) to the 2D memory array 150 such that the corresponding x- and y-offsets in the respective 2D memory array 150 relative to the START pointer (hereinafter called “Xₘₐ” and “Yₘₐ,” respectively) are given by:

Xₘₐ=(CURRENTX+X_{ref})% WIDTH (1);

Yₘₐ=(CURRENTY+Y_{ref})% HEIGHT (2),

where “%” is the modulus operator that divides the first operand (e.g., CURRENTX+X_{ref}) by the second operand (e.g., WIDTH) and returns only the remainder.

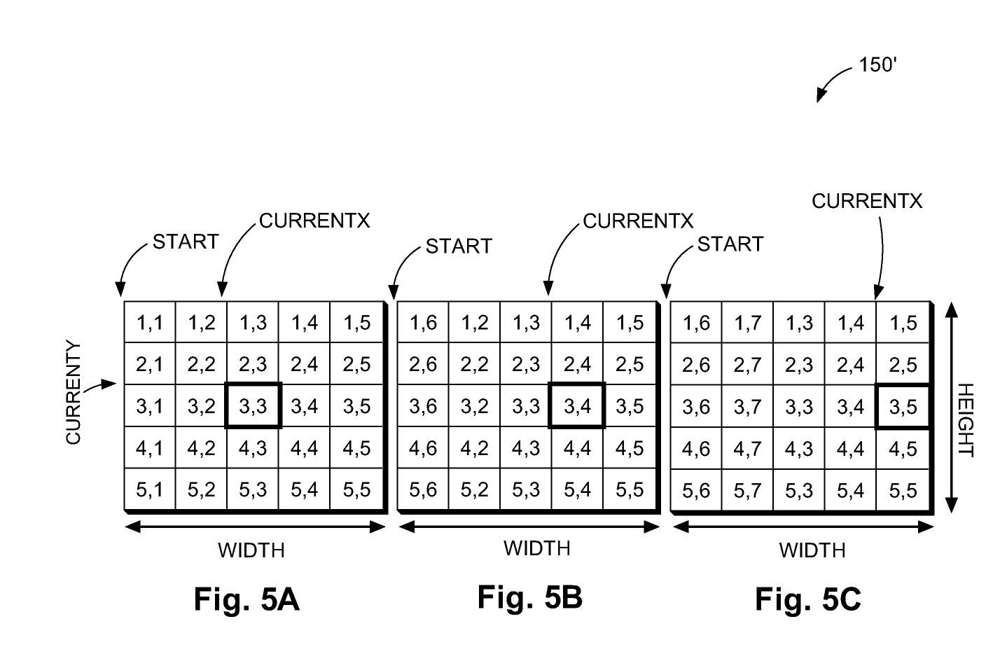

FIGS. 5-7 go on to show how the data processing system 100 may implement the above-described processes with three differently sized versions of the 2D memory array 150, labeled 150′, 150″, and 150′″, respectively, according to illustrative embodiments of the invention. In each of these embodiments, only the missing data for each new search area is preferably written to the 2D memory arrays 150′, 150″, 150′″, to the extent possible, in order to reduce the transfer of redundant data in the manner just described and thereby gain the related speed advantages. In addition, the new data is written modulo the width and height of the 2D memory arrays 150′, 150″, 150′″.

FIG. 5A, for example, shows a diagrammatic representation of the data content in the illustrative 2D memory array 150′, while FIGS. 5B and 5C show the manner in which that data is updated for search areas associated with two additional neighboring macro blocks (in this case moving left-to-right in a row with a constant CURRENTY), according to aspects of the invention. More specifically, FIGS. 5A-5C show the content of the 2D memory array 150′ starting with the search area associated with macro block MB(3,3) and updated for subsequent macro blocks MB(3,4) and MB(3,5). In this particular embodiment, the width and height of the 2D memory array 150′ are just sufficient to store a search area. The 2D memory array 150′ may, as just an example, have a width and height sufficient to store data representing 80×80 pixels of the reference video frame.

As will be observed in FIGS. 5B and 5C, updating the 2D memory array 150′ with the data for the search areas corresponding to macro blocks MB(3,4) and MB(3,5) is performed by writing one column of data at a time for each search update. In this manner, most of the content of the 2D memory array 150′ need not be modified. Only new information that is required for each new macro block replaces the old information, which is no longer required for the new macro block. Memory bandwidth is thereby conserved.

While memory bandwidth is positively impacted when utilizing the 2D memory array 150′, it will, nevertheless, be noted that the loading of the search areas in the 2D memory array 150′ occurs by serial execution. In other words, only when the search for a given retrieving macro block is completed is the missing information for the next retrieving macro block loaded. The use of serial execution may be mitigated to some extent by increasing the size of the 2D memory array.

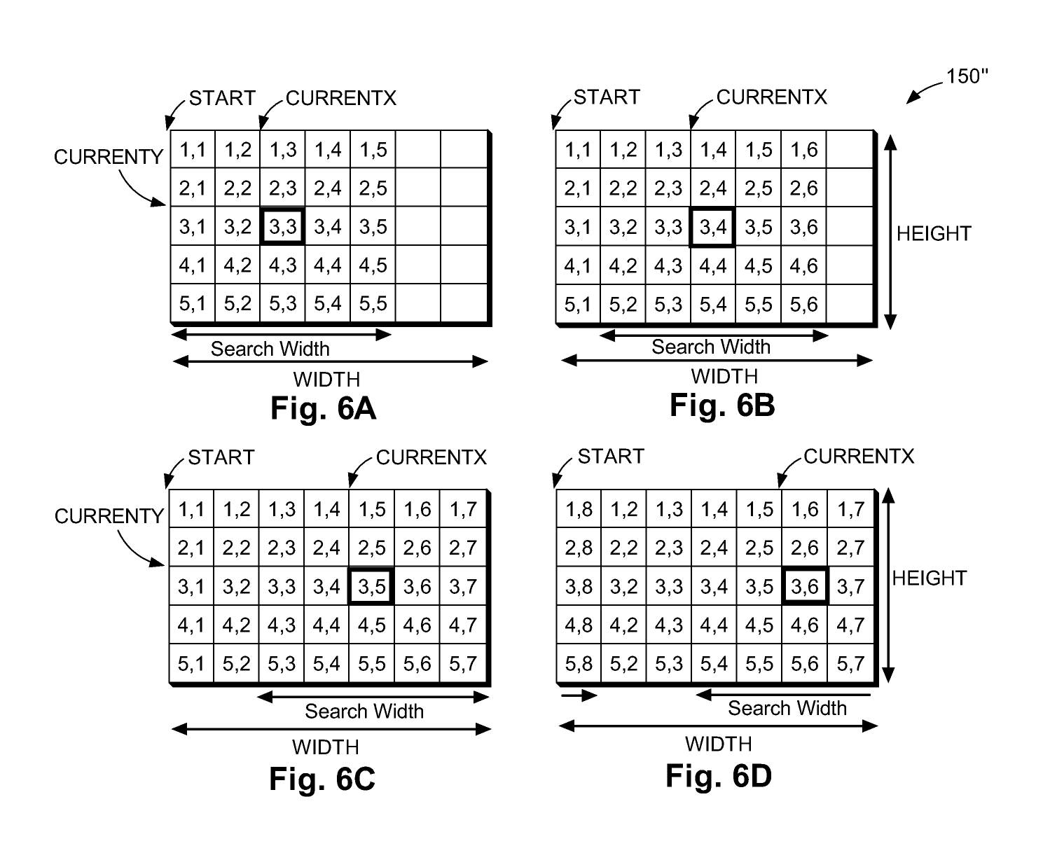

FIG. 6A, for example, shows a diagrammatic representation of the data content in the illustrative 2D memory array 150″ for MB(3,3), while FIGS. 6B-6D show the manner in which that data is updated for search areas associated with three additional neighboring macro blocks, MB(3,4), MB(3,5), and MB(3,6), respectively. Here the width of the 2D memory array 150″ is greater than the width needed to store a search area (represented by “Search Width” on the figures), while the height remains just sufficient. The 2D memory array 150″ is therefore laterally oversized. The 2D memory array 150″ may, in a non-limiting example, have a width and height sufficient to store data representing 112×80 pixels of the reference video frame.

Advantageously, the additional width allows data relevant to future search areas to be written to the 2D memory array 150″ before it is needed without corrupting the information required for the current macro block search. The additional data may, for example, be fetched while the processing core 110 is busy performing other tasks such as performing block matching for the current macro block. Stalls between searches for two neighboring macro blocks like those found in the 2D memory array 150′ may thereby be reduced or eliminated.

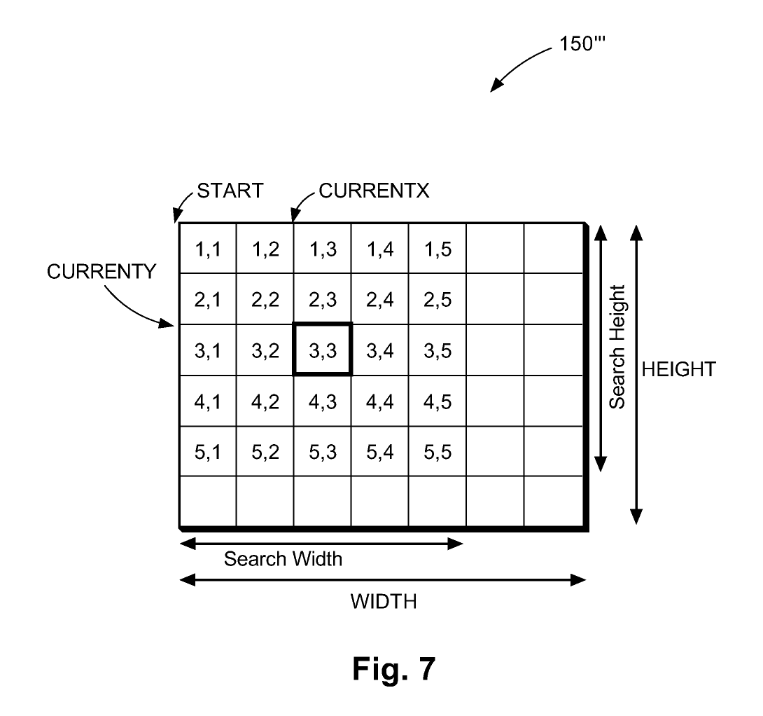

FIG. 7, moreover, shows a diagrammatic representation of the data content in the illustrative 2D memory array 150′″, according to another embodiment of the invention. Here, both the width and height of the 2D memory array 150′″ are greater than the width and height, respectively, needed to store a search area (represented by “Search Width” and “Search Height,” respectively, on the figure). The 2D memory array 150′″ is thereby laterally and vertically oversized. The 2D memory array 150′″ may, for example, have a width and height sufficient to store data representing 112×112 pixels of the reference video frame. With this configuration, both columns and rows of additional data may be written to the 2D memory array 150′″ ahead of time without affecting the information required for the current macro block. Again, stalls are avoided by utilizing the 2D memory array 150′″ with dimensions greater than that just sufficient to store a search area.

It is noted that the embodiments described with reference to the 2D memory arrays 150′, 150″, 150′″ in FIGS. 5-7 may benefit from using an alternating raster pattern as opposed to a standard raster pattern. As described earlier, when utilizing a standard raster pattern, the next retrieving macro block after reaching the rightmost or leftmost macro block in a row of a current video frame is the macro block in the row immediately below that last retrieving macro block, but now at the opposite edge of the video frame. The respective search areas associated with the two retrieving macro blocks may therefore not overlap. Accordingly, at these transitions, the entire content of the 2D memory arrays 150′, 150″, 150′″ may need to be replaced (i.e., flushed) when moving to a new line of macro blocks. Flushing operations such as these may not be ideal from the standpoint of minimizing the transfer of redundant data. If, instead, an alternating raster pattern is utilized with any one of the 2D memory arrays 150′, 150″, 150′″, these flushing operations may be avoided. Nevertheless, it is recognized that embodiments of the invention provide advantages no matter which type of raster pattern is utilized. The present invention is not intended to be limited to any particular raster pattern.

Advantageously, with the data stored in the 2D memory array 150 in the manner provided above, the processor core 110 may, in accordance with aspects of the invention, perform transactions on that data utilizing a simple but novel dual-increment addressing mode. In an illustrative and non-limiting embodiment of the invention, the processing core 110 may, for example, fetch a long word of data (i.e., four bytes of data) from the 2D memory array 150 and write that data to a register utilizing a fetch instruction that might look as follows:

move.1(r0)+X_{ref}:Y_{ref}, d0,

where “move.1” corresponds to the fetch of a long word, r0 is the location of the 2D memory array 150 in the internal memory 120, and d0 is a register to which the information is written. In conducting the transaction, the Xₘₐ and Yₘₐ are calculated utilizing the equations (1) and (2) provided above with reference to CURRENTX, CURRENTY, WIDTH, and HEIGHT. Ultimately, the address of the data being sought in the 2D memory array 150, ADDRESS, is simply:

ADDRESS=Xₘₐ+Yₘₐ*WIDTH (3).

In this manner, the addressing mode preferably allows instructions to continue addressing the data in terms of the x- and y-positions in the reference video frame (i.e., X_{ref} and Y_{ref}). Since the accesses from the processor core 110 will not go beyond the search range, they will necessarily address data within the Search Width and Search Height from the pointers CURRENTX and CURRENTY in the 2D memory array 150.

The invention can employ hardware or hardware and software aspects. Software includes but is not limited to firmware, resident software, microcode, etc. One or more embodiments of the invention or elements thereof can be implemented in the form of an article of manufacture including a machine readable medium that contains one or more programs which when executed implement such step(s); that is to say, a computer program product including a tangible computer readable recordable storage medium (or multiple such media) with computer-usable program code configured to implement the method indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a tangible computer-readable recordable storage medium (or multiple such media). Appropriate interconnections via bus, network, and the like can also be included.

With reference again to FIG. 1, memory (e.g., main memory 140) configures the processing core 110 to implement one or more aspects of the methods, steps, and functions disclosed herein (e.g., method 200 shown in FIG. 2). The memory 140 could be distributed or local and the processing core 110 could be distributed or singular. The memory 140 could be implemented as an electrical, magnetic or optical memory, or any combination of these or other types of storage devices. It should be noted that if distributed processors are employed, each distributed processor that makes up processing core 110 generally contains its own addressable memory space. It should also be noted that some or all of computer system 100 can be incorporated into an application-specific or general-use integrated circuit. For example, one or more method steps could be implemented in hardware in an ASIC rather than using firmware.

As is known in the art, at least a portion of one or more aspects of the methods and apparatus discussed herein may be distributed as an article of manufacture that itself includes a computer readable medium having non-transient computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store, in a non-transitory manner, information suitable for use with a computer system may be used. The computer-readable code means is intended to encompass any mechanism for allowing a computer to read instructions and data, such as magnetic variations on a magnetic medium or height variations on the surface of a compact disk. As used herein, a tangible computer-readable recordable storage medium is intended to encompass a recordable medium, examples of which are set forth above, but is not intended to encompass a transmission medium or disembodied signal.

The computer systems and servers described herein each contain a memory that will configure associated processors to implement the methods, steps, and functions disclosed herein. Such methods, steps, and functions can be carried out, e.g., by processing capability on individual elements in the other figures, or by any combination thereof. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the present invention can make use of computer technology with appropriate instructions to implement the methodologies described herein.

As used herein, a “server” includes a physical data processing system (for example, system 700 as shown in FIG. 7) running a server program. It will be understood that such a physical server may or may not include a display, keyboard, or other input/output components.

Furthermore, it should be noted that any of the methods described herein can include an additional step of providing a system comprising distinct software modules embodied on one or more tangible computer readable storage media. All the modules (or any subset thereof) can reside on the same medium, or each module can reside on a different medium, for example. The modules can include any or all of the components shown in the figures (e.g., DMAC module 130 shown in FIG. 1, and any sub-modules therein). Methodologies according to embodiments of the invention can then be carried out using the distinct software modules of the system, as described above, executing on the one or more hardware processors (e.g., a processor or processors in the motion estimation system). Further, a computer program product can include a tangible computer-readable recordable storage medium with code adapted to be executed to carry out one or more steps of the illustrative methodologies described herein, including the provision of the system with the distinct software modules.

Non-limiting examples of languages that may be used include markup languages (e.g., hypertext markup language (HTML), extensible markup language (XML), standard generalized markup language (SGML), and the like), C/C++, assembly language, Pascal, Java, and the like.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

System(s) have been described herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors such as video processors, digital signal processors (DSPs), etc. Thus, for example, DMAC module 130 shown in FIG. 1 (or any other blocks, components, sub-blocks, sub-components, modules and/or sub-modules) may be realized by one or more video processors. A video processor may comprises a combination of digital logic devices and other components, which may be a state machine or implemented with a dedicated microprocessor (e.g., CPU) or micro-controller running a software program or having functions programmed in firmware.

At least a portion of the techniques of the present invention may be implemented in an integrated circuit. In forming integrated circuits, identical die are typically fabricated in a repeated pattern on a surface of a semiconductor wafer. Each die includes an element described herein, and may include other structures and/or circuits. The individual die are cut or diced from the wafer, then packaged as an integrated circuit. One skilled in the art would know how to dice wafers and package die to produce integrated circuits. Any of the exemplary elements illustrated in, for example, FIG. 1, or portions thereof, may be part of an integrated circuit. Integrated circuits so manufactured are considered part of this invention.

Moreover, it should again be emphasized that the above-described embodiments of the invention are intended to be illustrative only. Other embodiments may use different types and arrangements of elements for implementing the described functionality. These numerous alternative embodiments within the scope of the appended claims will be apparent to one skilled in the art given the teachings herein.

Lastly, the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

What is claimed is:

1. A data processing system for processing a video stream, the data processing system comprising:
memory array circuitry, the memory array circuitry characterized by a width and a height;
memory access circuitry, the memory access circuitry operative to cause, through a series of write operations, a series of two-dimensional data representations of different respective regions in a frame of the video stream to be stored in the memory array circuitry, the write operations occurring such that only data missing from the memory array circuitry is written to the memory array circuitry during each write operation and such that the data is written modulo at least one of the width and the height of the memory array circuitry; and
video processing circuitry, the video processing circuitry operative to perform block matching on the video stream at least in part utilizing the series of two-dimensional data representations stored in the memory array circuitry.

2. The data processing system of claim 1, wherein the memory array circuitry comprises a random access memory.

3. The data processing system of claim 2, wherein the random access memory comprises at least one of a dynamic random access memory and a static random access memory.

4. The data processing system of claim 1, wherein the memory array circuitry comprises zero wait-state memory.

5. The data processing system of claim 1, further comprising main memory circuitry distinct from the memory array circuitry, wherein a write operation in the series of write operations comprises writing data from the main memory circuitry to the memory array circuitry.

6. The data processing system of claim 5, wherein the video processing circuitry is able to access data stored in the memory array circuitry substantially faster than it is able to access data stored in the main memory circuitry.

7. The data processing system of claim 5, wherein the main memory circuitry has a substantially larger data capacity than the memory array circuitry.

8. The data processing system of claim 1, wherein the memory access circuitry comprises a direct memory access controller.

9. The data processing system of claim 8, wherein the direct memory access controller is operative to cause data to be written to the memory array circuitry while the video processing circuitry is simultaneously performing other tasks.

10. The data processing system of claim 1, wherein the video processing circuitry is operative to access the data in the memory array circuitry utilizing a dual-increment addressing mode.

11. The data processing system of claim 1, wherein the video processing circuitry is operative to access data in the memory array circuitry at least in part by specifying the position of that data in the frame of the video stream.

12. The data processing system of claim 1, wherein the video processing circuitry is operative to compress the video stream in conformity with an MPEG Standard.

13. The data processing system of claim 1, wherein the video processing circuitry is operative to compress the video stream at least in part by motion estimation.

14. The data processing system of claim 1, wherein at least some of the series of two-dimensional data representations stored in the memory array circuitry represent regions of a reference video frame to be searched while performing block matching.

15. The data processing system of claim 1, wherein the block matching utilizes search regions that may, at minimum, be represented by a two-dimensional data representation with a particular width and a particular height, and wherein the memory array circuitry has a width substantially equal to the particular width and a height substantially equal to the particular height.

16. The data processing system of claim 1, wherein the block matching utilizes search regions that may, at minimum, be represented by a two-dimensional data representation with a particular width and a particular height, and wherein the memory array circuitry has at least one of a width substantially greater than the particular width and a height substantially greater than the particular height.

17. A method of processing a video stream, the method comprising the steps of:
causing, through a series of write operations, a series of two-dimensional data representations of different respective regions in a frame of the video stream to be stored in memory array circuitry defined by a width and a height, the write operations occurring such that only data missing from the memory array circuitry is written to the memory array circuitry during each write operation and such that the data is written modulo at least one of the width and the height of the memory array circuitry; and
performing block matching on the video stream at least in part utilizing the series of two-dimensional data representations stored in the memory array circuitry.

18. The method of claim 17, further comprising the step of storing at least a portion of the processed video stream on a non-transitory storage medium.

19. An integrated circuit for processing a video stream, the integrated circuit comprising:
memory array circuitry, the memory array circuitry characterized by a width and a height;
memory access circuitry, the memory access circuitry operative to cause, through a series of write operations, a series of two-dimensional data representations of different respective regions in a frame of the video stream to be stored in the memory array circuitry, the write operations occurring such that only data missing from the memory array circuitry is written to the memory array circuitry during each write operation and such that the data is written modulo at least one of the width and the height of the memory array circuitry; and
video processing circuitry, the video processing circuitry operative to perform block matching on the video stream at least in part utilizing the series of two-dimensional data representations stored in the memory array circuitry.
